(19) United States
(12) Patent Application Publication
(10) Pub. No.: US 2023/0129511 A1
(43) Pub. Date: Apr. 27, 2023

(54) METHODS, SYSTEMS, ARTICLES OF MANUFACTURE AND APPARATUS TO IMPROVE DISTRIBUTED MACHINE LEARNING EFFICIENCY

(71) Applicant: Intel Corporation, Santa Clara, CA (US)

(72) Inventors: Arvind Merwaday, Beaverton, OR (US); Satish Jha, Portland, OR (US); S M Iftekharul Alam, Hillsboro, OR (US); Vesh Raj Sharma Banjade, Portland, OR (US); Kuilin Clark Chen, Portland, OR (US)

(21) Appl. No.: 18/146,295

(22) Filed: Dec. 23, 2022

(51) Int. Cl. G06N 3/08

(52) U.S. Cl. CPC G06N 3/08

(57) ABSTRACT

Methods, apparatus, systems, and articles of manufacture are disclosed to improve distributed machine learning efficiency. An example apparatus includes train management circuitry to cause a first vector to be sent from a worker node to an in-network-aggregator (INA) after completion of a first processing iteration requested by a parameter server. The example apparatus also includes protocol configuration circuitry to prohibit a second processing iteration when an availability status of the INA is false, and permit the second processing iteration when (a) an acknowledgement (ACK) from the INA corresponding to the first vector is received and (b) the availability status of the INA is true.

### FIELD OF THE DISCLOSURE

This disclosure relates generally to machine learning and, more particularly, to methods, systems, articles of manufacture and apparatus to improve distributed machine learning efficiency.

### BACKGROUND

In recent years, deep neural networks (DNNs) have been used to solve advanced tasks. Typically, DNNs and other models are improved and/or otherwise tuned by calculating model gradient data. Such gradient data permits modification of the model so that a subsequent use of that model generates improved results. Any number of model gradient iterations may be performed in an effort to improve the underlying model.

### BRIEF DESCRIPTION OF THE DRAWINGS

FIG. 1 is a sequence diagram illustrating example aggregation protocol techniques.

FIG. 2 is a sequence diagram illustrating example aggregation protocol techniques to improve distributed machine learning efficiency constructed in a manner consistent with this disclosure.

FIGS. 3A and 3B are schematic illustrations of example network environments to improve distributed machine learning efficiency.

FIG. 4A is a block diagram of example distributed machine learning (DML) circuitry to improve DML efficiency.

FIG. 4B is a block diagram of an example framework to facilitate in-network aggregation.

FIG. 5 illustrates an example middleware packet format implemented by the example DML circuitry of FIGS. 4A and/or 4B to improve DML efficiency.

FIG. 6 is an example sequence diagram corresponding to configuration of the example network environments of FIGS. 3A and 3B.

FIG. 7 is an example sequence diagram corresponding to training operations within the example network environments of FIGS. 3A and 3B.

FIGS. 8-11 are flowcharts representative of example machine readable instructions and/or example operations that may be executed by example processor circuitry to implement the DML circuitry of FIG. 4A and/or the example framework of FIG. 4B.

FIG. 12 is a block diagram of an example processing platform including processor circuitry structured to execute the example machine readable instructions and/or the example operations of FIGS. 8-11 to implement the DML circuitry of FIG. 4A and/or the example framework of FIG. 4B.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 8-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

While deep neural networks (DNNs) enable problem solving for complicated tasks, such DNNs require training that has become increasingly compute and communication intensive. DNN training typically involves workloads that occur in datacenters and/or using distributed node resources. While such computing resources are robust, they are in high demand for utilization. The complexity of DNN models is increasing exponentially, and this complexity increase is expected to continue into the future. For instance, the Generative Pre-trained Transformer-2 (GPT-2) is a general-purpose learning model released in 2019 that includes approximately 1.5 billion parameters. Subsequent improvements were applied to create GPT-3 in 2020, which includes approximately 175 billion parameters. Further generations of transformers are expected to include approximately 100 trillion parameters, so the burden on datacenters is likewise expected to increase. During training workloads that use data-parallel and/or model-parallel approaches, communication tasks during these training efforts exhibit a major performance bottleneck that limits training speed and causes instances of resource idle time.

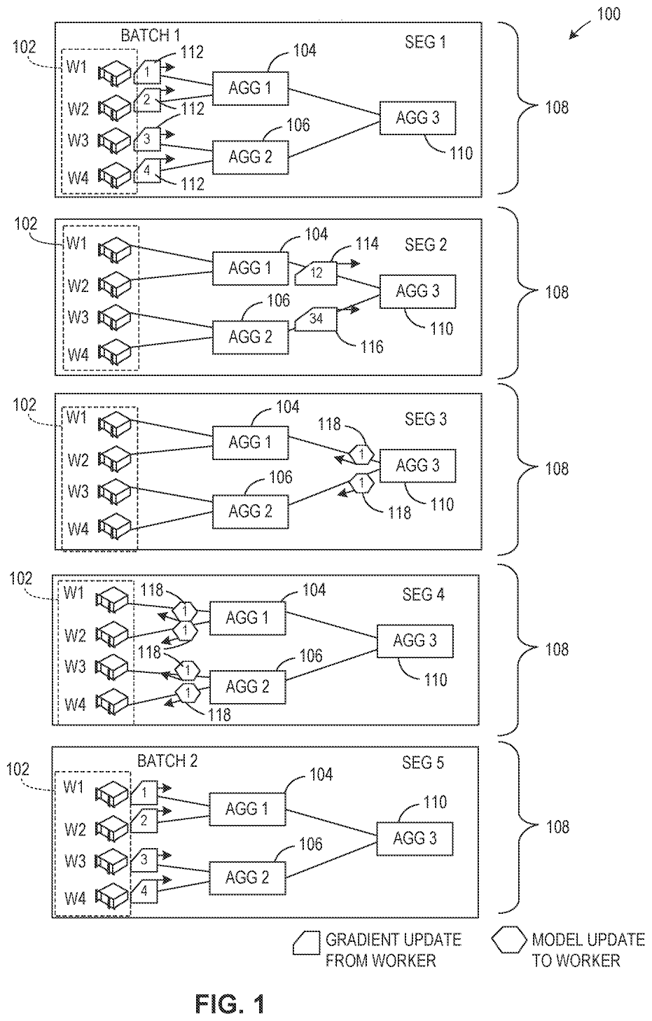

FIG. 1 is a sequence diagram 100 corresponding to current aggregation protocol techniques. In FIG. 1, the sequence diagram 100 includes five (5) example segments, each of which includes four (4) worker nodes 102 labelled “w1,” “w2,” “w3,” and “w4.” The example structure within each of the five example segments is generally referred to as an aggregation tree 108, which each segment includes the same structure shown at different temporal moments in an effort to explain the current (e.g., state-of-the-art) aggregation protocol techniques. The example worker nodes 102, sometimes referred to herein as computing resources, workload resources, or worker resources, may include any type of computing resource capable of executing tasks and/or workloads, such as tasks and/or workloads related to gradient calculations for machine learning models (e.g., DNNs).

Generally speaking, gradient calculations occur at the worker nodes 102 in response to receiving a model from one or more parameter servers (PSs) (discussed in further detail below). Results from the gradient calculations performed by the worker nodes 102 are processed by the one or more PS s, and the one or more PS s update the models to be returned to the worker nodes 102 for further gradient calculations in an iterative manner. As such, communication bandwidth within one or more aggregation trees 108 becomes significant as DNNs become more complex.

Each of the five segments in FIG. 1 include the same aggregation tree 108 that includes worker nodes w1 and w2 communicatively connected to a first aggregator 104 (“Agg 1”) and worker nodes w3 and w4 communicatively connected to a second aggregator 106 (“Agg 2”). Additionally, in each of the five example segments in the illustrated example of FIG. 1, each aggregation tree 108 includes a third aggregator 110 (“Agg 3”) communicatively connected to the example first aggregator 104 and the second aggregator 106. As used herein, the aggregators are also referred to as in-network aggregators (INAs). INAs can be implemented using programmable switches or network attached accelerators (NAAs) that may include field programmable gate arrays (FPGAs), application specific integrated circuits (ASICs), graphics processing units (GPUs), etc.

In operation, the worker nodes 102 send gradient updates in batches to the example third aggregator 110. In some examples, the third aggregator 110 aggregates and/or otherwise accumulates gradient data (e.g., vectors of data) from the worker nodes 102 and any intermediate aggregators to be sent to a parameter server for further processing (e.g., model development). When an aggregation batch (e.g., batch 1) from the example worker nodes 102 to the last node (e.g., the third aggregator 110) in the aggregation tree 108 is complete, results of that batch are returned to the worker nodes 102. When the worker nodes 102 receive the results, this serves as an acknowledgement (ACK) to inform the worker nodes 102 that they may initiate a new iteration of processing, such as renewed efforts to calculate gradient values corresponding to a model of interest. However, unless and until the worker nodes and/or any other structure of the example aggregation tree 108 receives an ACK, such structure remains idle and/or otherwise non-productive.

To illustrate, in Segment 1 of the illustrated sequence diagram 100 of FIG. 1 includes all worker nodes 102 sending respective gradient update data 112 to the respective first aggregator 104 and the respective second aggregator 106. In some examples, gradient update data is referred to herein as a vector, a data vector, a data packet, or a workload. In Segment 2 of the illustrated sequence diagram 100 of FIG. 1 the first aggregator 104 sends a first aggregated vector 114 containing the individual vectors from the first (w1) and second (w2) worker nodes, and the second aggregator 106 sends a second aggregated vector 116 containing the individual vectors from the third (w3) and fourth (w4) worker nodes. In Segment 3 of the illustrated sequence diagram 100 of FIG. 1, the third aggregator 110 has presumably processed the received aggregated data and sends back model update data 118 to be used by the worker nodes 102 so that subsequent gradient calculations may occur (e.g., corresponding to an alternate model of interest, and/or corresponding to an updated version of the same model of interest). However, before such subsequent gradient calculations can occur, the model update data 118 must finish its propagation through the aggregation tree 108 to reach the worker nodes 102. As described above, the worker nodes 102 continue to remain idle and/or otherwise stalled during this propagation.

In Segment 4 of the illustrated sequence diagram 100 of FIG. 1, the first aggregator 104 and the second aggregator 106 send the model update data 118 to the worker nodes 102. At this point, the receipt of the model update data 118 by the worker nodes 102 serves as an ACK to inform the worker nodes that they may continue processing (e.g., begin gradient calculations in view of new model data) rather than remain idle. In Segment 5 of the illustrated sequence diagram 100 of FIG. 1, the worker nodes may repeat a new batch (e.g., batch 2) of calculated gradient data to be sent to a destination of the example aggregation tree 108 (e.g., the example third aggregator 110). As shown in FIG. 1 and described above, current approaches to dynamic model training suffer from computing resource inefficiency caused by idle and/or otherwise stalled resources. Additionally, idle resources cannot advance model training and, necessarily, cause model training efforts to consume additional time to complete (unless additional resources are spun up and/or otherwise allocated). Furthermore, current techniques limit the worker nodes to analysis of a single model of interest during iterative data propagation through the example aggregation tree 108. However, merely adding more computational resources to a particular workload or task cause extra cost, energy consumption and/or heat generation, thereby thwarting initiatives to conserve energy (e.g., “green initiatives”).

Examples disclosed herein improve an efficiency of aggregator resources and also improve (e.g., reduce) an amount of time required to perform training tasks. Additionally, examples disclosed herein permit the worker nodes to perform gradient calculations for alternate models of interest during the time in which gradient data from one or more gradient calculations propagates through the example aggregation tree 108. In particular, examples disclosed herein employ a pipeline-based protocol flow for aggregation trees.

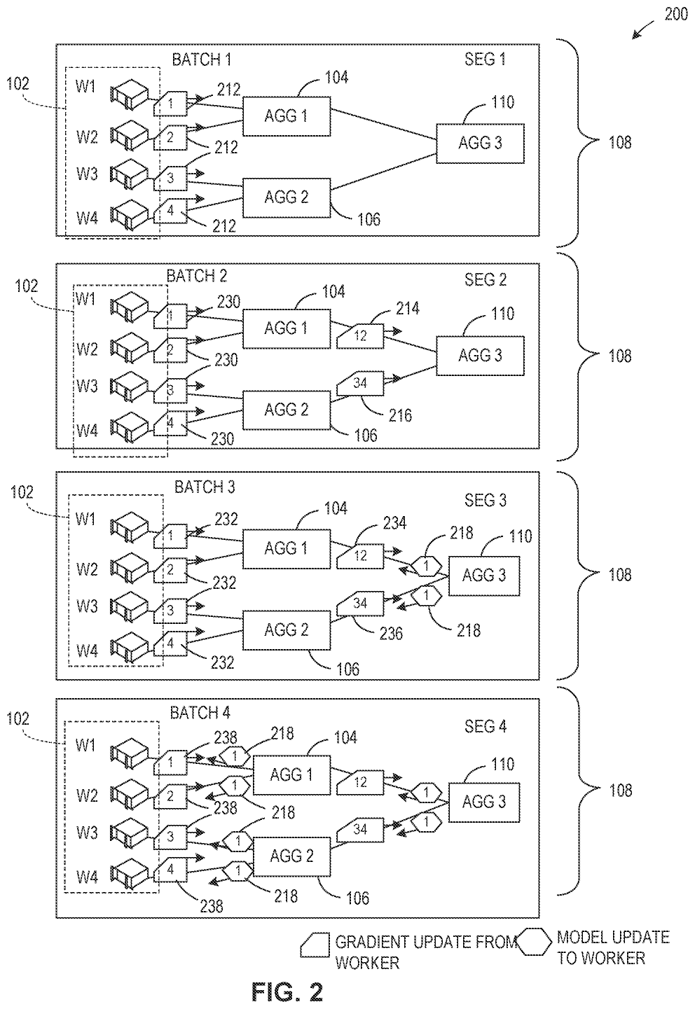

FIG. 2 is a sequence diagram 200 corresponding to improved aggregation protocol techniques disclosed herein. In the illustrated example of FIG. 2, the sequence diagram 200 includes the same worker nodes 102 and the same aggregation tree 108 structure as shown in FIG. 1. However, while segment 1 through step 4 of FIG. 1 illustrate processing of a single batch (e.g., “batch 1” corresponding to gradient calculations for a single model of interest), segment 1 through step 4 of the illustrated example of FIG. 2 illustrate processing of four separate batches of gradient calculation data.

Segment 1 of FIG. 2 illustrates all worker nodes 102 sending respective first gradient update data 212 to the respective example first aggregator 104 and the respective second aggregator 106. In Segment 2 of the illustrated example sequence diagram 200 of FIG. 2 the first aggregator 104 and the respective second aggregator 106 receive the first gradient update data 212 and, in some examples, return an acknowledgement (ACK) back to the sending worker nodes 102 to inform them that another batch of gradient data may be sent. In some examples, the aggregator (e.g., the first aggregator 104) sends two or more pieces of information to each worker node, both of which are required before permitting the worker node to proceed with a subsequent calculation iteration. For instance, a first ACK identifies success of the worker node vector being received by the aggregator, and a second ACK identifies the fact that the aggregator is ready to receive additional data from the worker node because the aggregator is not waiting on vectors from other worker nodes and/or other INAs. In some examples, a single ACK is sent by the aggregator only when those two conditions are true (that is, the worker node vector was successfully received and the aggregator has already received a corresponding vector from the other worker nodes and/or sub-aggregators connected downstream.

Continuing with the example of Segment 2, the example first aggregator 104 generates a first aggregated vector 214 that includes gradient data from worker node w1 and worker node w2. The example second aggregator 106 generates a second aggregated vector 216 that include gradient data from worker node w3 and w4. The first aggregated vector 214 and the second aggregated vector 216 are sent and/or otherwise transmitted by the first aggregator 104 and the second aggregator 106 to the third aggregator 110, respectively. However, while the first aggregator 104 and the second aggregator 106 are transmitting aggregated vector data further down the aggregation tree 108 (e.g., the aggregation pipeline), the worker nodes 102 send second gradient update data 230 (e.g., gradient calculations corresponding to another model of interest) as inputs to the first aggregator 104 and the second aggregator 106. Stated differently, examples disclosed herein enable the worker nodes 102 to continue (a) calculating gradients and (b) sending gradient result data despite the fact that the initial gradient data may still be propagating within the gradient tree 108.

Segment 3 of the illustrated example of FIG. 2 includes a third batch of gradient data 232 calculated by the worker nodes 102, which is transmitted to the first aggregator 104 and the second aggregator 106 as inputs thereto. At substantially the same time, the first aggregator 104 transmits a third aggregated vector 234 and the second aggregator 106 transmits a fourth aggregated vector 236 to the third aggregator 110. Still at substantially the same time, the third aggregator 110 transmits first model update data 218, which corresponds to the first gradient update data generated by the worker nodes 102 during the first batch (“batch 1”). Generally speaking, examples disclosed herein enable structure(s) within the aggregation tree 108 to participate in transmission and receipt of data at substantially the same time from one batch to another. In some examples, “substantially the same time” or “substantially simultaneously” includes circumstances where aggregation tree 108 structure conducts a data receive operation before conducting a data transmit operation, or vice versa (e.g., half duplex structure versus full duplex structure).

Segment 4 of the illustrated example of FIG. 2 includes a fourth batch of gradient data 238 generated by the worker nodes 102. Similar to pipeline behavior described above, the first aggregator 104 and the second aggregator 106 receive the fourth batch of gradient data 238 while also returning the example first model update data 218 back to the worker nodes 102 so that they may begin further gradient calculations in view of the new/updated model update data 218 (and another iteration batch to ultimately send back through the example gradient tree 108).

While the illustrated example of FIG. 2 includes a portion of an aggregation tree 108, examples disclosed herein are not limited to a single aggregation tree.

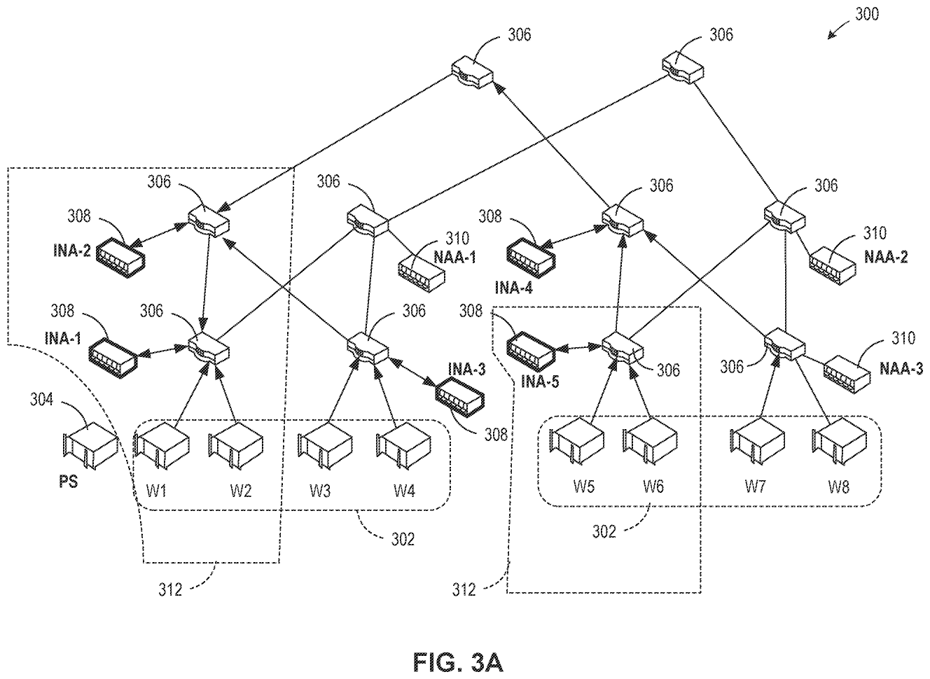

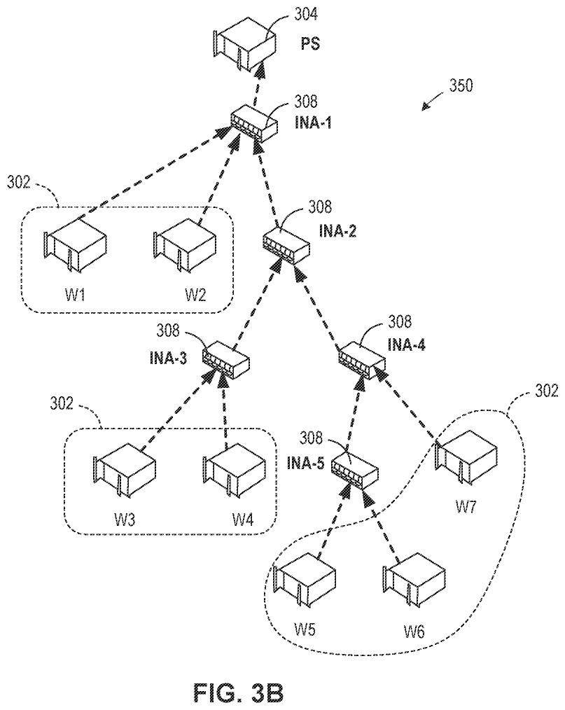

FIGS. 3A and 3B illustrate example network environments in which examples disclosed herein may operate. In the illustrated example of FIG. 3A, an example first network environment 300 (sometimes referred to herein as a “framework” or “topology”) includes any number of worker nodes 302 (also referred to herein as server nodes) shown as w1 through w8. The example worker nodes 302 may be geographically distributed in any manner and communicate with an example parameter server (PS) 304. As described above, the example PS 304 may be chartered with the responsibility of model development and/or training, in which the PS is sometimes referred to herein as a primary computing device or orchestrator device. In view of the increasing complexity and size of machine learning models, assistance from any number of worker nodes 302 helps to calculate gradient information to aid with training in view of computationally burdensome numbers of model parameters. While the example PS 304 may manage model training and distribution, the worker nodes 302 provide gradient information to allow the PS 304 to generate and/or otherwise build one or more models and/or updated (e.g., improved) versions of the one or more models. Such models are provided to the example worker nodes 302 so that gradient calculations may be performed in view of any particular model of interest.

In the illustrated example of FIG. 3A, the worker nodes 302 are communicatively connected to respective programmable switches 306. FIG. 3A also includes in-network-aggregators (INAs) 308 communicatively connected to the example programmable switches 306. The example INAs 308 of FIG. 3A may be any type of network accelerator or network attached accelerator (NAA) 310, in which some of those NAAs are selected, structured and/or otherwise configured to operate as INAs 308. In operation, the example INAs 308 aggregate vectors (e.g., gradient data) from two or more other nodes, such as example worker nodes 302, programmable switches 306 and/or other INAs 308. The illustrated example of FIG. 3A may be considered an aggregation tree that includes any number of aggregation sub-trees 312 as logical or physical groupings of node structure within the example environment 300.

In the illustrated example of FIG. 3B, similar structure includes similar nomenclature and numbering values as shown in the illustrated example of FIG. 3A. FIG. 3B includes a second aggregation environment 350 (sometimes referred to herein as a “framework” or “topology”) having worker nodes 302 labeled w1 through w7. Communication to/from the example worker nodes 302 is aggregated and/or otherwise controlled with INAs 308, in which INA-5 aggregates data to/from worker nodes w5 and w6, INA-4 aggregates data to/from worker node w7 and INA-5, INA-3 aggregates data to/from worker nodes w3 and w4, INA-2 aggregates data to/from INA-3 and INA-4 (but has no direct communication with worker nodes 302), and INA-1 aggregates data to/from worker nodes w1 and w2 and INA-2. Finally, the example PS 304 receives aggregated data from INA-1. In the examples of FIGS. 3A and 3B, using traditional gradient calculation techniques the worker nodes 302 would need to remain idle after sending a batch of gradient data to the example PS 304 unless and until the example PS 304 returns an ACK to the respective worker nodes 302. As such, the traditional gradient calculation techniques cause resource stalling and render computing resources in an idle and/or otherwise non-productive state for each batch of gradient data (and each model iteration of interest). Contrary to traditional gradient calculation techniques, examples disclosed herein enable computing nodes of gradient trees and gradient sub trees to prevent resource stalling by processing data without relatively lengthy delays caused by propagation delay between the PS 304 and respective worker nodes 302.

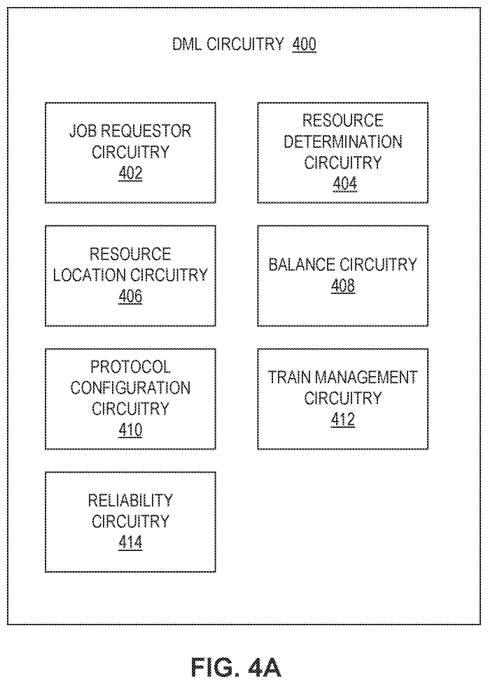

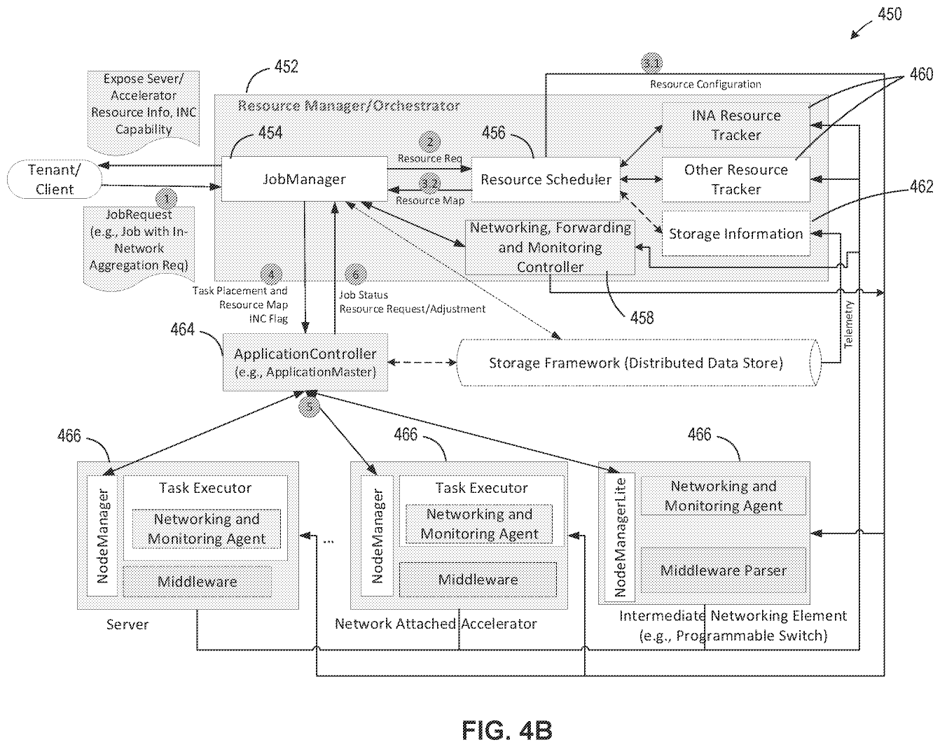

FIG. 4A is a block diagram of example distributed machine learning (DML) circuitry 400 to improve distributed machine learning efficiency. The DML circuitry 400 of FIG. 4A may be instantiated (e.g., creating an instance of, bring into being for any length of time, materialize, implement, etc.) by processor circuitry such as a central processing unit executing instructions. Additionally or alternatively, the DML circuitry 400 of FIG. 4A may be instantiated (e.g., creating an instance of, bring into being for any length of time, materialize, implement, etc.) by an ASIC or an FPGA structured to perform operations corresponding to the instructions. It should be understood that some or all of the circuitry of FIG. 4A may, thus, be instantiated at the same or different times. Some or all of the circuitry may be instantiated, for example, in one or more threads executing concurrently on hardware and/or in series on hardware. Moreover, in some examples, some or all of the circuitry of FIG. 4A may be implemented by microprocessor circuitry executing instructions to implement one or more virtual machines and/or containers.

In the illustrated example of FIG. 4A, the DML circuitry 400 includes example job requestor circuitry 402, example resource determination circuitry 404, example resource location circuitry 406, example balance circuitry 408, example protocol configuration circuitry 410, example train management circuitry 412 and example reliability circuitry 414. In some examples, the job requestor circuitry 402 is instantiated by processor circuitry executing job requestor instructions and/or configured to perform operations such as those represented by the flowcharts disclosed herein. In some examples, the resource determination circuitry 404 is instantiated by processor circuitry executing resource determination instructions and/or configured to perform operations such as those represented by the flowcharts disclosed herein. In some examples, the resource location circuitry 406 is instantiated by processor circuitry executing resource location instructions and/or configured to perform operations such as those represented by the flowcharts disclosed herein. In some examples, the balance circuitry 408 is instantiated by processor circuitry executing balance instructions and/or configured to perform operations such as those represented by the flowcharts disclosed herein. In some examples, the protocol configuration circuitry 410 is instantiated by processor circuitry executing protocol configuration instructions and/or configured to perform operations such as those represented by the flowcharts disclosed herein. In some examples, the train management circuitry 412 is instantiated by processor circuitry executing train management instructions and/or configured to perform operations such as those represented by the flowcharts disclosed herein. In some examples, the reliability circuitry 414 is instantiated by processor circuitry executing reliability instructions and/or configured to perform operations such as those represented by the flowcharts disclosed herein.

In operation, the example DML circuitry 400 is located within particular nodes and/or structure of a network to manage a communication protocol between such structure. In some examples, the DML circuitry 400 is referred to as “middleware” to manage and/or otherwise control example pipeline based protocols for in-network gradient aggregation disclosed herein. In some examples, the DML circuitry 400 is located within and/or otherwise operates in the example worker nodes 102 and aggregators of FIGS. 1 and 2. In some examples, the DML circuitry 400 is located within and/or otherwise operates in the example worker nodes 302, the example INAs 308, the example NAAs 310 and/or the example PS 304 of FIGS. 3A and 3B. In some examples, aggregation tree behavior is controlled and/or otherwise managed by the DML circuitry 400 at an orchestrator node or PS 304 and requests are made to obtain resources to facilitate inter-node communication.

In some examples, the DML circuitry 400 uses any number of transport layer protocols for communication of different types of information. For instance, the DML circuitry 400 causes a user datagram protocol (UDP) transport for communication with worker nodes and INAs when sending/receiving gradient update information and/or aggregated results in an upward direction of an aggregation tree (or sub-aggregation tree). In some examples, the DML circuitry 400 causes a transmission control protocol (TCP) transport to ensure reliable unicast communication of control plane messages among and between the PS 304, worker nodes 304, INAs 308 and/or a resource orchestrator/manager (RO/M). The example RO/M (sometimes referred to herein as an “orchestrator”) may be designated by the DML circuitry 400 during a resource allocation task, which could include a high-availability server within the environment that includes a relatively robust suite of computational capabilities when compared to other computational resources of the environment. For instance, the orchestrator may be designated as one of the INAs 308 or other server that is backed-up and capable of hot swapping in the event of a failure. In some examples, the DML circuitry 400 designates a multicast protocol (e.g., Pragmatic General Multicast, data distribution service (DDS), etc.) for sending model parameters and/or updates from the example PS 304 to the worker nodes 302.

FIG. 4B is a block diagram of an example framework 450 to improve distributed machine learning efficiency. In some examples, the framework 450 utilizes and/or otherwise invokes structure from the illustrated example of FIG. 4A. In the illustrated example of FIG. 4B, the framework 450 includes an example resource manager (orchestrator) 452, which includes an example job manager 454, an example resource scheduler 456, an example networking controller 458, example resource trackers 460 and an example data store 462. In operation, a requestor provides the example job manager 454 with a request, such as a request for in-network aggregation of data. The example resource scheduler 456 receives this request and interacts with one or more resource trackers 460 to identify candidate resources that can accommodate and/or otherwise execute the job request. Additionally, the example resource scheduler 456 seeks information from storage devices 462 to determine whether they are available to assist in the job (e.g., data aggregation from any number of nodes). Based on available resources, the example resource scheduler 456 generates and sends a resource map to the job manager 454 so that particular resources can be invoked for tasks/workload.

The example framework 450 also includes an application controller 464 communicatively connected to the job manager 454. The example application controller 464 receives one or more resource requests that the job manager 454 is aware of and invokes the services of those available resources 466, such as servers, network attached accelerators, and/or other network elements (computing devices). The example application controller 464 also retrieves status information from the invoked resources 466 and provides such information to the job manager 454 to be shared with the requestor (e.g., status updates).

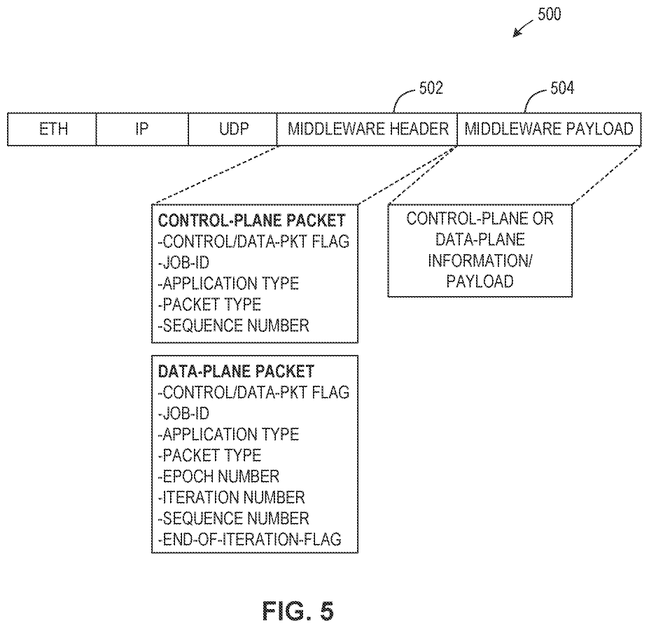

During communication tasks by the example DML circuitry 400 described above and in further detail below, an example packet format is implemented. FIG. 5 illustrates an example middleware packet format 500 that includes an example middleware header 502 and an example middleware payload 504. In the illustrated example of FIG. 5, the middleware header 502 includes a control/data packet field to indicate whether a corresponding packet is part of a control plane packet or a data plane packet. The middleware header 502 also includes a job-identifier (ID) field to track a unique identifier of an application instance or task.

In some examples, the job-ID facilitates vector tracking during communication iterations between nodes of the aggregation tree(s) to accommodate for circumstances where a particular vector does not successfully propagate from one node (e.g., a worker node) to another node (e.g., an INA). In some examples, the middleware header 502 includes an application type field to identify and/or otherwise indicate a type of an application with which the communication is associated (e.g., a gradient calculation application, a DML training application type, etc.). In some examples, the middleware header 502 includes a packet type field to distinguish the possibility of any number of different packet types within the data and/or control plane. In some examples, the middleware header 502 includes an epoch number field to indicate a particular epoch number to which the packet belongs (e.g., a number of iterations a model of interest has had its gradient calculated and/or otherwise updated). In some examples, the middleware header 502 includes a status field, such as an INA status field that operates like a flag. In the event the INA status field/flag is true (e.g., an indication of binary “1”, “TRUE”, etc.), then examples disclosed herein can cause awareness of whether a particular network element (e.g., an INA) is capable of receiving input data. As such, an INA field set to true (e.g., “TRUE”) will cause corresponding network elements to permit the transfer of data and/or otherwise permit processing iterations to proceed. On the other hand, in the event the INA field is set to false (e.g., “FALSE”), processing iterations are prohibited because any additional output from such processing iterations cannot be accepted as input by the network element that exhibits a false INA field.

In some examples, the middleware header 502 includes an iteration number field to identify a current iteration number that a packet belongs to within an epoch (e.g., each epoch typically requires several iterations to complete). In some examples, the middleware header 502 includes a sequence number field to identify and/or otherwise indicate a sequence number of the packet within an iteration. For instance, a gradient update from a worker node may be segmented into several smaller packets, each having a unique sequence number within the iteration. In the case of a control packet, the sequence number indicates a latest packet of the same packet type. In some examples, the middleware header 502 includes an end-of-iteration field to identify and/or otherwise indicate a last gradient packet of an iteration, which may be used by INAs to handle timers and/or end-to-end reliability tasks.

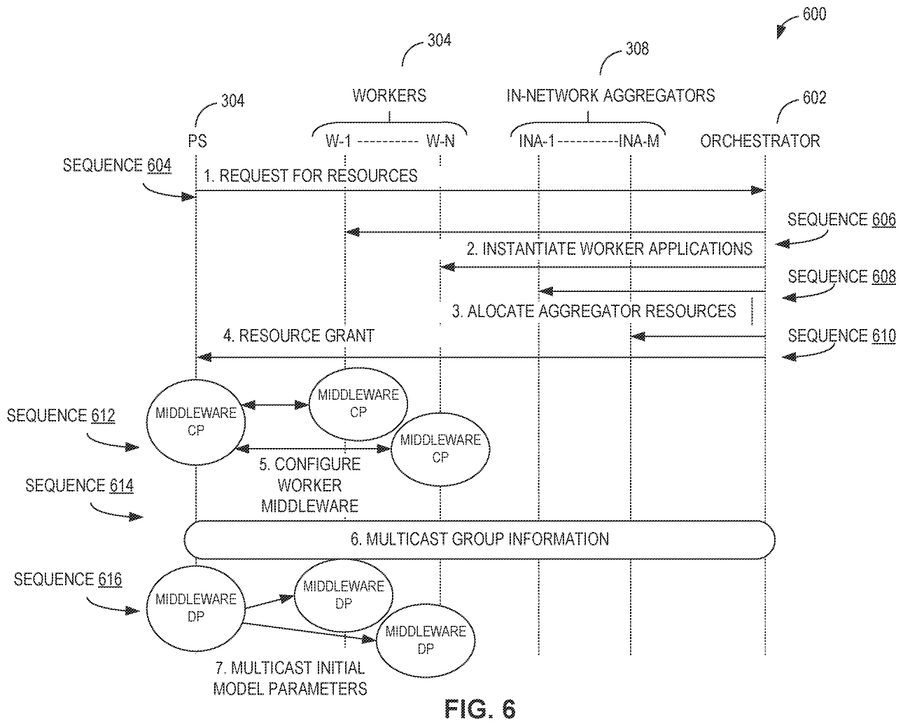

FIG. 6 is a sequence diagram 600 corresponding to the example network environment 300 of FIG. 3A, the example network environment 350 of FIG. 3B and/or the corresponding structure of FIGS. 4A and/or 4B. In the illustrated example of FIG. 6, the sequence diagram 600 includes the example parameter server (PS) 304. The illustrated example of FIG. 6 also includes any number and/or type of worker nodes 302 (labeled as w1 through wn), any number and/or type of in-network-aggregators (INAs) 308, and an example orchestrator 602. As described above, the example orchestrator 602 may include one of the worker nodes, one of the INAs and/or any other highly available computing resource (e.g., a high-performance server) communicatively connected to the structure of an aggregation tree(s). The example sequence diagram 600 of FIG. 6 will be discussed in connection with the structure of FIG. 4A, in which the example DML circuitry 400 may operate, structurally reside, execute within and/or otherwise be causing the structure of FIG. 6 to operate. In some examples, the DML circuitry 400 facilitates operations of the example sequence diagram 600 of FIG. 6 by executing in a client/server manner and/or by executing in a centrally located computing resource.

In operation, the example job requestor circuitry 402 determines whether a gradient aggregation job request has been instantiated, which may be caused by a request from the example PS 304 (sequence 604). If so, the example distributed machine learning (DML) circuitry 400 determines whether a DML framework has been established, such as an aggregation tree containing structure capable of implementing examples disclosed herein that also include the DML circuitry 400. If a DML framework has not yet been established, then the example resource determination circuitry 404 identifies candidate and/or otherwise capable orchestrator circuitry (e.g., the example orchestrator 602) that includes the DML circuitry 400 (e.g., or a container/API capable of implementing the functions of the DML circuitry 400). While the example resource determination circuitry 404 may identify any number of candidate orchestrator resources (e.g., computing resources that are relatively robust, backed up in anticipation of possible failure, etc.), some of those candidate orchestrator resources may be located at different physical distances from the resources of an aggregation tree (e.g., distances as measured in physical proximity, a number of node hops, etc.). In an effort to reduce propagation delay that may be exacerbated by resources that are located farther away from each other, the example resource location circuitry 406 selects and/or otherwise designates one of the candidate orchestrators for the aggregation tree.

The example job requestor circuitry 402 requests any number of resources to execute one or more job requests, such as requests from the example PS 304 to initiate gradient aggregation and/or model update jobs/tasks. In particular, the example resource determination circuitry 404 sends details of required resources, such as a number of needed worker nodes, a number of GPUs, a number of in-network aggregators (INAs), and a number of aggregation trees that will participate in the requested jobs (sequence 604). The example resource location circuitry 406 causes the example orchestrator 602 to locate worker nodes (sequence 606) and, based on the locations of the worker nodes, the resource location circuitry 406 locates corresponding INAs (sequence 608). When forming one or more aggregation trees, the example orchestrator circuitry 602 selects INAs in each tree in a hierarchical manner, in which aggregator registers are allocated that can each handle a single gradient. An aggregator unit size (e.g., a number of allocated registers in an INA) determines a packet size of gradient updates from worker nodes. In some examples, the resource determination circuitry 404 tracks INA resources to maintain information about availability thereof, and the example resource location circuitry 406 assists in selections of INAs near worker nodes, as described above. Considering dynamic changes to network traffic, the resource determination circuitry 404 conducts such analysis on a periodic, aperiodic and/or scheduled basis to balance loads on INAs.

After resource allocation and tree formation has been completed, the example job requestor circuitry 402 waits for a resource grant message (e.g., from the example orchestrator 602) to indicate that the tree is ready for operation (sequence 610). In some examples, the grant message includes Internet protocol (IP) addresses corresponding to allocated worker nodes 302 and INA resources 308. Additionally, the grant message may identify details corresponding to one or more aggregation trees that have been configured, such as a tree identifier, hierarchical topology information, multicast IP address information, a number of allocated aggregator registers for each INA, size and type information of aggregator registers, etc.

The example protocol configuration circuitry 410 configures communication instructions for nodes within the aggregation trees (sequence 612). In particular, the protocol configuration circuitry 410 configures each worker node behavior (e.g., middleware) by sending control plane messages with aggregation related parameters. Example parameters include, but are not limited to a unique job identifier to use in gradient update packets, a number of participating aggregation trees and corresponding tree IDs, IP addresses for participating INAs, multicast IP addresses for each participating aggregation tree through which worker nodes receive model parameter updates, a number of allocated aggregator registers in participating INAs, initial epoch and/or iteration count, etc. The example protocol configuration circuitry 410 also configures multicast groups (sequence 614), and sends initial model(s) to worker nodes (e.g., via a multicast protocol) (sequence 616).

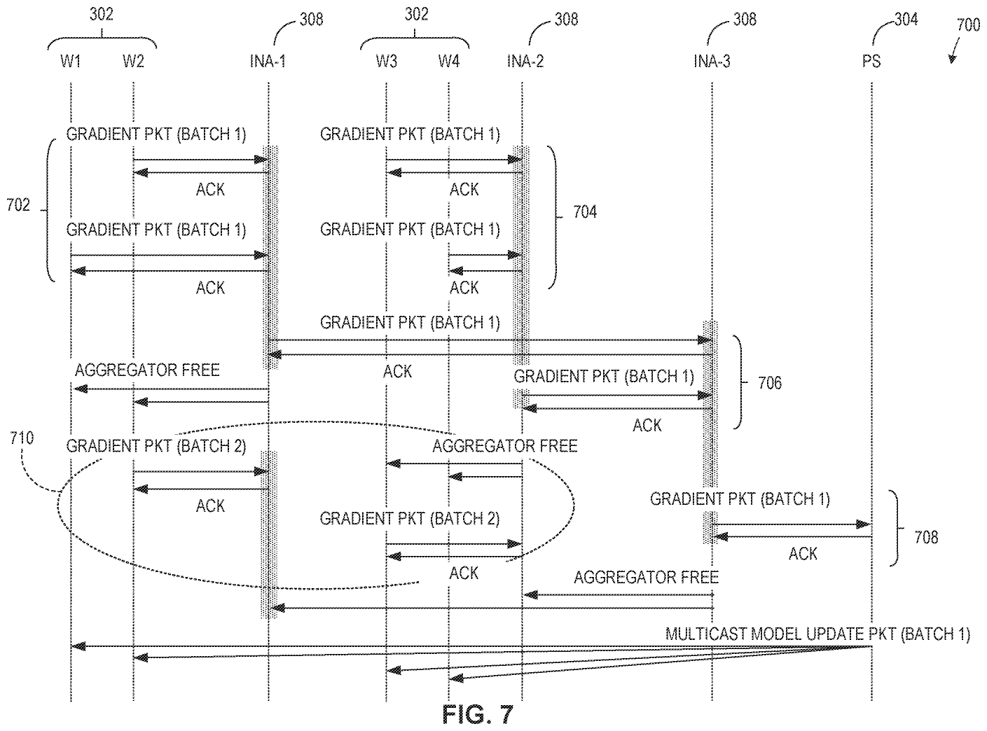

While the illustrated example sequence diagram 600 of FIG. 6 discloses example configuration of one or more aggregation trees and/or structure thereof, FIG. 7 illustrates an example sequence diagram and topology 700 corresponding to protocol flow (e.g., middleware) during DML training. In the illustrated example of FIG. 7, the sequence diagram 700 includes example worker nodes 302 labeled w1 through w4, example INAs 308 labeled INA-1, INA-2 and INA3, and the example PS 304. The topology 700 of FIG. 7 illustrates gradient updates from worker nodes w1 and w2 are aggregated by INA-1, and gradient updates from w3 and w4 are aggregated by INA-2. Additionally, aggregations from INA-1 and INA-2 are further aggregated by INA-3.

In operation, after worker nodes 302 complete a training iteration in which gradient data is generated/calculated, the worker nodes 302 w1 and w2 send an example first batch (Batch 1) to INA-1 (sequence 702) and the worker nodes 302 w3 and w4 send their corresponding first batch (Batch 1) to INA-2 (sequence 704). In the illustrated example of FIG. 7, acknowledgement based reliability is used by INA-1 and INA-2 to send acknowledgement (ACK) packets back to the senders to acknowledge receipt of gradient packets. As described above, in some examples INA-1 and INA-2 only send ACK packets back to the senders (e.g., worker nodes 302) after two conditions are met. That is, a first condition requires the INAs to receive a packet from a worker node, and a second condition requires the INAs to confirm that all associated worker nodes have provided their corresponding packets. When those conditions are not satisfied and/or otherwise false, the INA is associated with an availability status of false and/or otherwise unavailable to receive a subsequent iteration of data. Additionally, while the INA is associated with the availability status of false, the corresponding worker nodes are prohibited and/or otherwise prevented from instantiating a subsequent iteration of calculation(s) (e.g., gradient calculations). As disclosed above, in some examples the protocol configuration circuitry examines a status of a flag to determine whether a particular network element is able to receive additional data (e.g., an INA status field). In the event a worker node queries an INA to determine a corresponding status is false, the worker node is prohibited from instantiating a subsequent iteration of calculations because doing so would result in lost data (e.g., data sent from a worker node to the INA that is incapable of receiving data would result in data loss). However, when the aforementioned conditions are satisfied, the INA is associated with an availability status of true and/or otherwise available to receive a subsequent iteration of data. Additionally, in response to the availability status of true the INA will transmit the ACK packet back to all associated worker nodes and/or sub-INAs of the aggregation tree, thereby permitting and/or otherwise allowing the worker nodes to proceed with a subsequent calculation effort (e.g., another gradient calculation). In other words, when all worker nodes have completed their gradient computation(s) and transmitted their packet vectors to the INA, then the INA is not waiting on one or more worker nodes before it can proceed with its aggregation efforts.

After INA-1 and INA-2 receive gradient packets from all expected worker nodes 302, INA-1 and INA-2 aggregate all received packets and send those corresponding aggregated packets to INA-3 (sequence 706). INA-3 then responds to INA-1 and INA-2 with an ACK, thereby releasing those INAs for future receipt of additional aggregated data, which also releases any worker nodes. At this point, because INA-1 and INA-2 are released and/or otherwise free, the worker nodes 302 may begin another (e.g., new) gradient calculation iteration (e.g., Batch 2) (sequence 710) despite the fact that the first batch has not yet fully propagated through the example framework 700 of FIG. 7 (e.g., data from batch 1 has not yet reached the example PS 304).

In the illustrated example of FIG. 7, after INA-3 receives gradient packets from INA-1 and INA-2, it sends those packets to the example PS 304, at which point the PS 304 sends an ACK to INA-3 (sequence 708). INA-3 releases aggregator registers and the example topology 700 is ready for a next batch, if any.

In some examples disclosed herein, one or more transport functionalities are employed, such as end-to-end reliability handling with latency bound by retransmission or repetition, packet segmentation considering resource limitations of aggregation trees, convergence of packet flows, aggregation-tree-based flow control and congestion control, etc. In the event of packet segmentation considering aggregation tree resources is employed by the example DML circuitry 400, after a worker node completes an iteration of DML training, it sends gradient updates in the form of a vector during the aggregation propagation (e.g., middleware tasks). The DML circuitry 400 chunks the vector into smaller segments based on a number of allocated aggregator registers corresponding to different aggregation trees. In some examples, a gradient vector is divided into several batches in which the size of each batch (e.g., the number of gradients) is determined in a manner consistent with example Equation 1.

$$batch = {\sum }_{n = 1}^{Ntrees} number of registers per INA tree ( n ) . \qquad Equation 1$$

A batch of gradients may be further divided into smaller segments of gradient packets as needed, in which each packet corresponds to a different aggregation tree. This arrangement permits all workers to perform segmentation in the same order and send packets to different aggregation trees in a same sequence to ensure the gradients of the same indices are aggregated together.

In some examples, the DML circuitry 400 employs end-to-end reliability with latency bounds and timeouts. For example, each worker node and INA uses a timer to trigger retransmission of a gradient packet in case it is lost or the ACK packet from a next level INA is lost. Retransmission timer values may be changed for each retransmission to accommodate for round trip metrics. In some examples, a maximum data retransmission parameter may be used to determine a maximum number of retransmission attempts, after which a worker node will report a failure (e.g., report a failure to the example PS 304). INAs 308 keep track of which nodes have been aggregated, such that the gradients from any one particular node are aggregated only one time per batch attempt. In some examples, INAs 308 use timers to trigger retransmission of an “aggregator free” packet to worker nodes 302 and/or lower-level INAs 308.

In some examples, the DML circuitry 400 employs a NACK-based reliability for improved protocol efficiency, which reduces protocol overhead. In operation, NACK-based approaches do not expect ACK feedback from INAs during gradient packet transmissions. In some examples, INAs 308 start a timer after receiving a first gradient packet for a batch and resets the timer for every subsequent gradient packet received. The timer is stopped after receiving all the expected gradient packets from worker nodes 302. In the event a packet gets lost, or if the timer expires, INAs 308 trigger retransmission of “aggregator free” packets and a failure is reported to the example PS 304.

In some examples, the DML circuitry 400 employs an aggregation-tree-based flow and congestion control. In operation, after a gradient packet is sent, the worker nodes and INAs wait for “aggregator free” responses from a next level INA before sending a subsequent gradient packet. In some examples, INAs 308 aggregate explicit congestion notification (ECN) values that are added by routers in worker node gradient packets and/or other in-band/out-of-band congestion signals. INAs then forward the congestion notification(s) to all connected lower-level worker nodes and/or lower-level INAs to that the input traffic from worker nodes can be regulated. INAs also notify the example PS 304 of congestion through out-of-band congestion notification control message(s). During aggregation efforts, all trees are block synchronized. Different aggregation trees may be synchronized at iteration levels, and worker nodes of an aggregation tree may be synchronized at a packet level. Thus, if a congestion occurs at any point, an aggregation process of the tree will suffer. In this case, the example PS 304 may take actions to improve training throughput by using congestion notification control messages from INAs. In particular, the PS can identify the impacted aggregation tree and redistribute the traffic by moving one or more worker nodes to non-congested trees. The PS may coordinate with workers, INAs and/or operators to pause training at a particular state (e.g., at the end of an iteration) and instantiate new worker nodes in those non-congested trees.

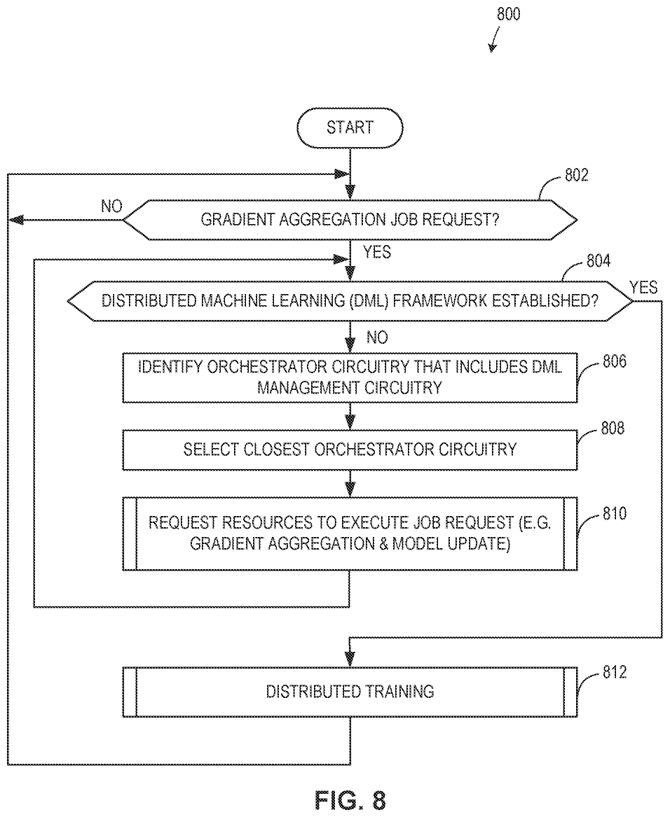

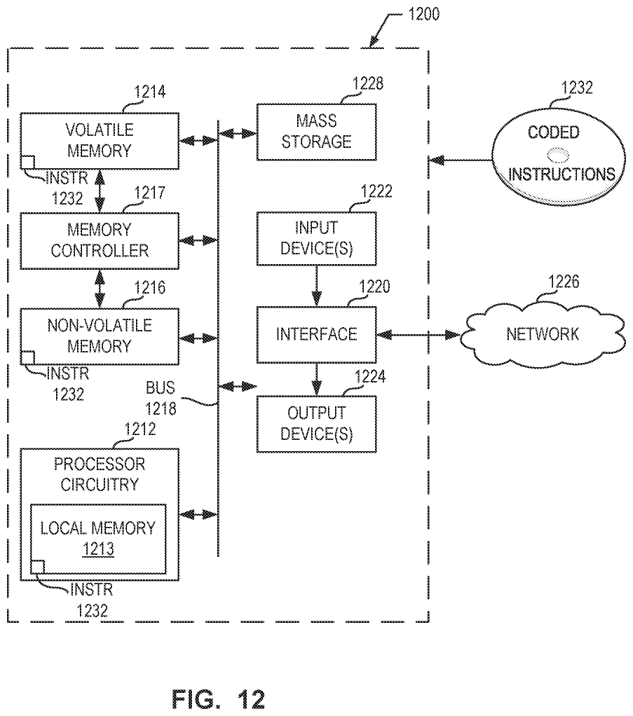

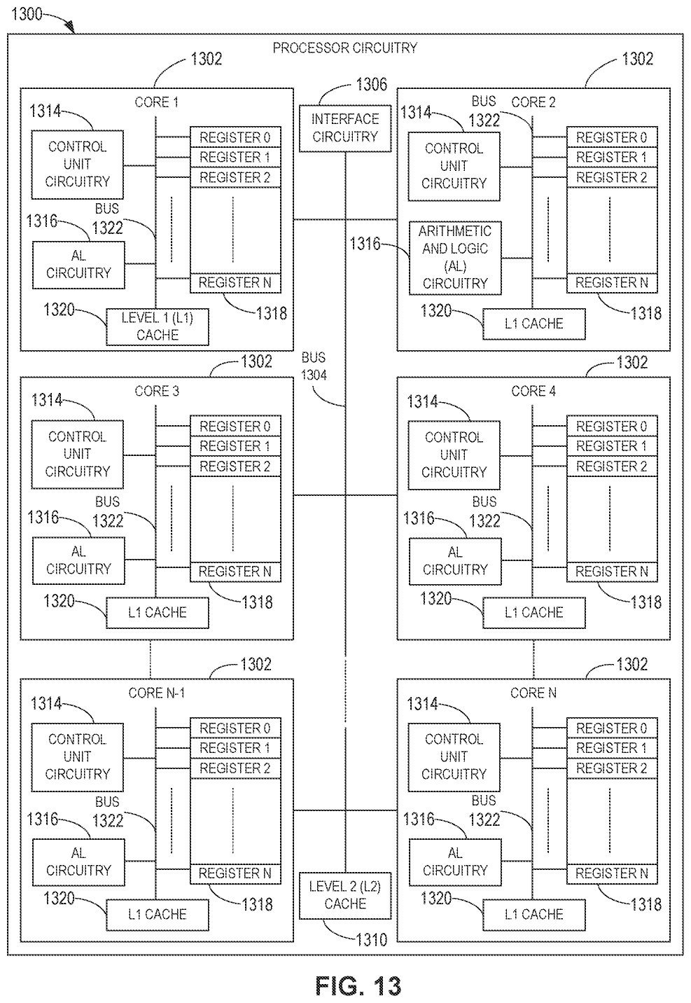

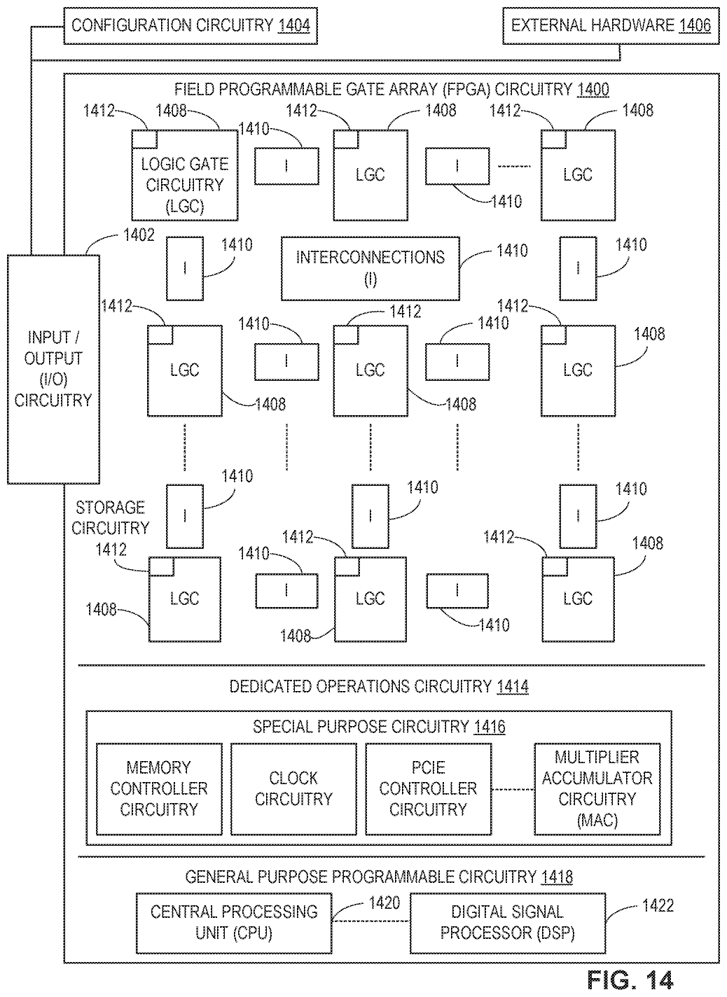

In some examples, the DML circuitry 400 includes means for job requests, means for resource determination, means for resource location determination, means for balancing, means for protocol configuration, means for training management, and means for reliability improvement. For example, the aforementioned means for may be implemented by, respectively, the example job requestor circuitry 402, the example resource determination circuitry 404, the example resource location circuitry 406, the example balance circuitry 408, the example protocol configuration circuitry 410, the example train management circuitry 412, and the example reliability circuitry 414. In some examples, the aforementioned circuitry may be instantiated by processor circuitry such as the example processor circuitry 1212 of FIG. 12. For instance, the aforementioned circuitry may be instantiated by the example microprocessor 1300 of FIG. 13 executing machine executable instructions such as those implemented by at least blocks of FIGS. 8-11. In some examples, the aforementioned circuitry may be instantiated by hardware logic circuitry, which may be implemented by an ASIC, XPU, or the FPGA circuitry 1400 of FIG. 14 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the DML circuitry 400 of FIG. 4A (and the example framework 454 of FIG. 4B) is illustrated in FIGS. 2, 3A, 3B and 5-7, one or more of the elements, processes, and/or devices illustrated in FIGS. 4A and/or 4B may be combined, divided, re-arranged, omitted, eliminated, and/or implemented in any other way. Further, the example job requestor circuitry 402, the example resource determination circuitry 404, the example resource location circuitry 406, the example balance circuitry 408, the example protocol configuration circuitry 410, the example train management circuitry 412, the example reliability circuitry 414 and/or, more generally, the example DML circuitry 400 of FIG. 4A, may be implemented by hardware alone or by hardware in combination with software and/or firmware. Thus, for example, any of the example job requestor circuitry 402, the example resource determination circuitry 404, the example resource location circuitry 406, the example balance circuitry 408, the example protocol configuration circuitry 410, the example train management circuitry 412, the example reliability circuitry 414 and/or, more generally, the example DML circuitry 400 of FIG. 4A (as well as the structure of framework 450 of FIG. 4B), could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example DML circuitry 400 of FIG. 4A and/or the framework 450 of FIG. 4B may include one or more elements, processes, and/or devices in addition to, or instead of, those illustrated in FIGS. 2, 3A, 3B and 5-7 and/or may include more than one of any or all of the illustrated elements, processes and devices.

Flowcharts representative of example machine readable instructions, which may be executed to configure processor circuitry to implement the DML circuitry 400 of FIG. 4A and/or the framework 450 of FIG. 4B, are shown in FIGS. 8-11. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 13 and/or 14. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 8-11, many other methods of implementing the example DML circuitry 400 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-11 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to configure a DML training system. The machine readable instructions and/or the operations 800 of FIG. 8 begin at block 802, at which the example job requestor circuitry 402 determines whether one or more gradient aggregation job requests have been invoked. As described above, the example parameter server (PS) 304 may initiate the request for jobs related to gradient calculations to be shared among available resources of a network. In some examples, the PS 304 includes models of interest that each require periodic improvement and/or updating, which is achieved through gradient calculations. As described above, particular ones of the models are provided to respective worker nodes for gradient calculation efforts, the results of which are eventually returned to the PS 304 so that the PS 304 may update the model in view of the gradient results. The process can then repeat as many times as needed for continuous improvement and/or training of the models of interest.

The example distributed machine learning (DML) circuitry 400 determines whether a DML framework has previously been established (block 804). If so, then it is assumed that resources have already been established and/or otherwise configured and distributed training may continue (block 812), as described in further detail below. However, if the example DML circuitry 400 determines that no prior DML framework has been established, such as the example framework 300 of FIG. 3A or the example framework 350 of FIG. 3B, then the example resource determination circuitry 404 identifies orchestrator circuitry that is suitable for configuration and management of a framework to be implemented (block 806). In particular, the example resource determination circuitry 404 searches available networked resources for those that also contain and/or otherwise execute instances of the example DML circuitry 400. Of the available resources identified by the example resource determination circuitry 404, the example resource location circuitry 406 determines which ones of those resources are closest to the example parameter server and/or worker nodes to participate in the gradient calculation efforts (block 808). As described above, “closest” may refer to a physical proximity metric, and/or may refer to a logical metric such as a number of network hops needed to reach the resource(s) of interest.

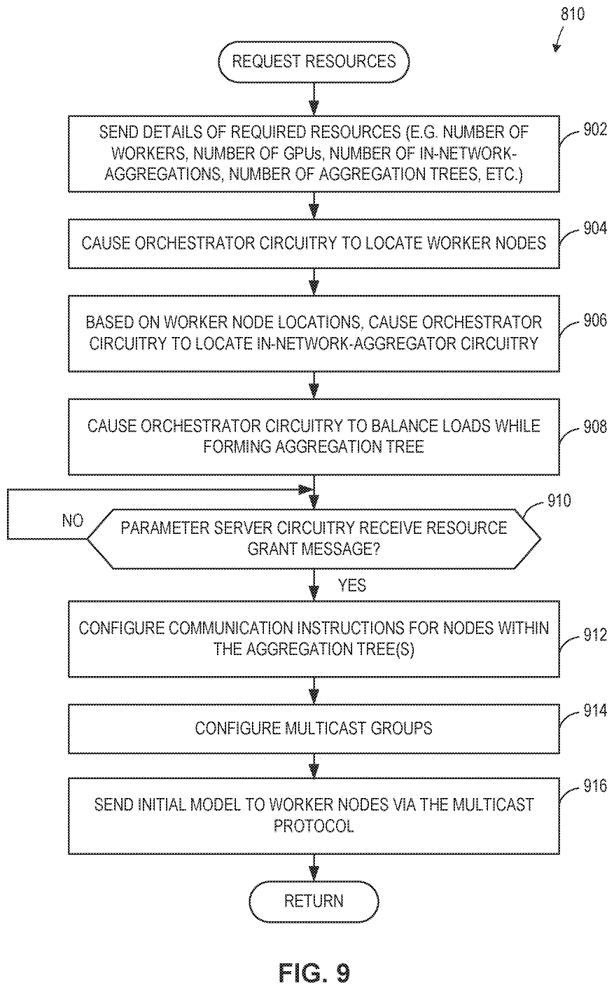

The example job requestor circuitry 402 requests resources to execute the job requests (block 810), as described in further detail in FIG. 9. In the illustrated example of FIG. 9, the resource determination circuitry 404 sends details of required resources to the established orchestrator (block 902). As described above, details of required resources may include, but are not limited to a number of worker nodes, a number of GPUs, a number of INAs, a number of aggregation trees, etc.). The example resource location circuitry 406 causes the example orchestrator (e.g., orchestrator circuitry 602) to locate candidate worker nodes (e.g., worker nodes 302) (block 904), and based on their locations, cause the example orchestrator 602 to locate corresponding INAs that are also proximate to the worker nodes (block 906). Depending on expected demand information corresponding to one or more job requests (e.g., one or more gradient calculation job requests from the example PS 304), the example balance circuitry 408 causes the orchestrator circuitry 602 to balance workloads when forming an aggregation tree (block 908). For example, some INAs are able to handle different loads (e.g., some have greater/lesser communication bandwidth capabilities) and, as a result, the orchestrator may assign a corresponding greater or lesser number of worker nodes to be handled by the INA.

The example job requestor circuitry 402 determines whether the PS 304 has received a resource grant message (block 910), which is indicative of one or more aggregation trees that have been assigned resources to handle the job requests. However, while resources may be assigned, they may not yet be configured to participate in one or more communication techniques disclosed herein (e.g., middleware configuration). If resources are not yet assigned to the aggregation trees, the example program 810 of FIG. 9 waits for such configuration efforts to complete (block 910). Otherwise, the example protocol configuration circuitry 410 configures communication instructions for nodes within the aggregation tree(s) (block 912). As disclosed above, the protocol configuration circuitry 410 sends control plane messages to each worker to override any default communication protocols (e.g., override default middleware protocols) that it may have. For instance, updated transmit/receive protocols that do not need to wait for batch information to propagate through the entire tree before allowing one or more subsequent gradient vectors to propagate in iterative succession.

The example protocol configuration circuitry 410 configures multicast groups (block 912), in which address information corresponding to aggregation trees, worker nodes and the PS are shared. After such configuration efforts are complete, the protocol configuration circuitry 410 sends at least one initial model to the worker nodes via the multicast protocol (block 916) so that such worker nodes can begin their efforts to calculate gradients (that will ultimately allow the performance and/or efficacy of the model(s) to improve). Control then returns to block 804 of FIG. 8 in which the example DML circuitry 400 determines whether the DML framework has been established and/or otherwise configured for runtime tasks.

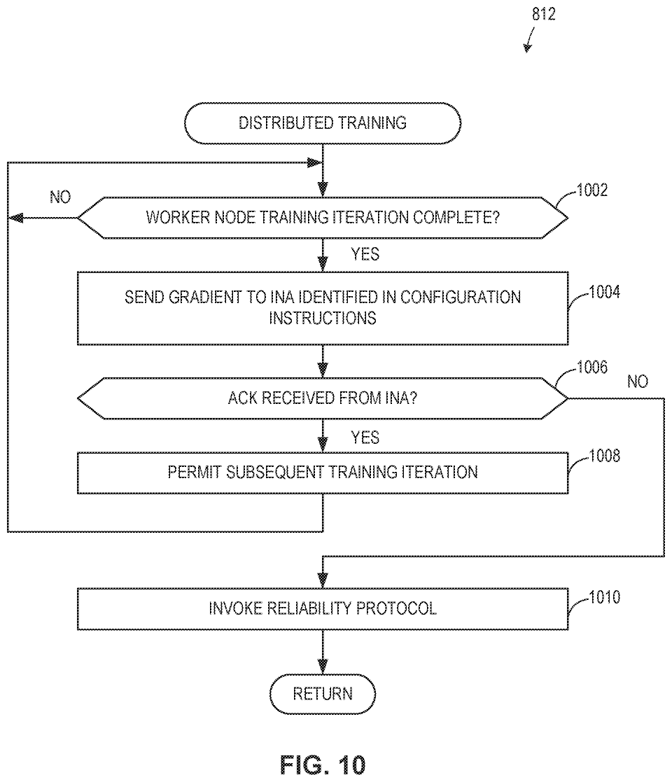

FIG. 10 is a flowchart corresponding to additional detail of distributed training (block 812) of FIG. 8. In the illustrated example of FIG. 10, the distributed training is described from a point of view of a worker node 302, in which the example train management circuitry 412 determines whether a worker node training iteration is complete (block 1002). For example, on a prior occasion the worker node 302 has received a model from the example PS 304 and the worker node 302 is chartered with the responsibility to calculate gradient vectors on behalf of the PS 304 request. As described above, because DNN models have become substantially more complex, training and improvement of such models requires computational assistance from disparate computing resources that are communicatively connected via one or more networks. Such a cooperative effort (by the worker nodes) reduces a burden on the example PS 304 to take responsibility for the entire training and improvement burden of the complex DNN models.

After the train management circuitry 412 within the worker node 302 determines that the training iteration is complete (block 1002), the example protocol configuration circuitry 410 sends the gradient data (e.g., gradient vector) to an INA that was identified in prior configuration instructions (block 1004). The example reliability circuitry 414 within the worker node 302 determines if an ACK has been received from the INA (block 1006). If so, then the example train management circuitry 412 permits the worker node 302 to initiate and/or otherwise instantiate another (e.g., subsequent) training iteration (block 1008), such as another/separate gradient calculation effort corresponding to the same or different model provided by the example PS 304. As disclosed above, traditional distributed training techniques do not permit and/or otherwise facilitate an ability for a worker node to engage in another gradient calculation unless and until an acknowledgement is received from the PS 304, in which the PS also transmits an updated model for the worker node to process. As such, examples disclosed herein avoid computational idle time by otherwise capable computational resources.

In the event the example reliability circuitry 414 determines that an ACK is not received from the worker node's corresponding INA (block 1006), then one or more reliability protocols is invoked (block 1010). As described above, reliability protocols include, but are not limited to an end-to-end reliability that is latency bound, or a NACK-based reliability protocol. Control then returns to block 802 of FIG. 8.

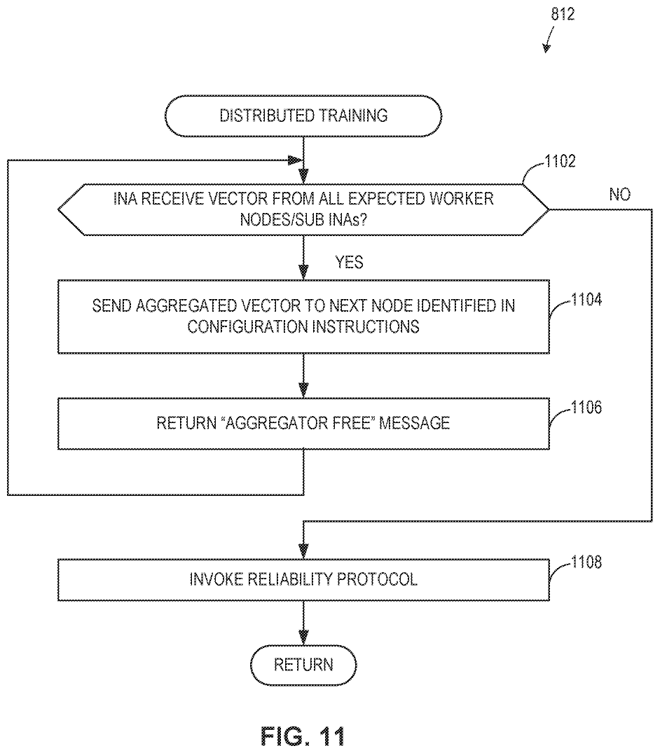

FIG. 11 is a flowchart corresponding to alternate additional detail of distributed training (block 812) of FIG. 8. Unlike the illustrated example of FIG. 10, which describes the distributed training from a point of view of a worker node 302, the illustrated example of FIG. 11 describes the distributed training from the point of view of an INA 308 connected to one or more worker nodes and/or an upstream/downstream INA. The example train management circuitry 412 of the INA determines whether it has received a vector from all expected worker nodes and/or sub-INAs (block 1102). If so, then the example protocol configuration circuitry 410 sends an aggregated vector to a next node identified in the configuration instructions (block 1104), which identify particular tree nodes and their communicatively connected tree nodes that facilitate communication between all worker nodes and, ultimately, the PS 304. After an aggregated vector is transmitted from the INA (block 1104), the example train management circuitry 412 returns an indication that the INA is available to receive additional aggregated vectors from subsequent batches computed by worker nodes and sub-INAs (block 1106). In other words, the example train management circuitry 412 sends an “aggregator free” message/flag to indicate the INA has the capability to propagate any additional aggregated vectors despite not receiving any confirmation from the PS 304 that a prior batch of vectors has been successfully received and/or processed. Again and as described above, this permits valuable node computing resources from sitting idle during vector propagation within any tree.

Briefly returning to block 1102, in the event the train management circuitry 412 determines that the INA did not receive a vector from all expected worker nodes and/or sub-INAs, then one or more reliability protocols is invoked to remedy and/or otherwise handle the communication error (block 1108). In some examples, because the above disclosed middleware packet format includes header information corresponding to each packet, individual ones of packets that have been lost may be re-transmitted in a manner consistent with the reliability protocol that is invoked by the train management circuitry 412. Control then returns to block 802 of FIG. 8.

FIG. 12 is a block diagram of an example processor platform 1200 structured to execute and/or instantiate the machine readable instructions and/or the operations of FIGS. 8-11 to implement the DML circuitry 400 of FIG. 4A and/or the example framework 450 of FIG. 4B. The processor platform 1200 can be, for example, a server, a personal computer, a workstation, a self-learning machine (e.g., a neural network), a mobile device (e.g., a cell phone, a smart phone, a tablet such as an iPad™), an Internet appliance, a gaming console, a set top box, a headset (e.g., an augmented reality (AR) headset, a virtual reality (VR) headset, etc.) or other wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the example job requestor circuitry 402, the example resource determination circuitry 404, the example resource location circuitry 406, the example balance circuitry 408, the example protocol configuration circuitry 410, the example train management circuitry 412, the example reliability circuitry 414, and more generally, the example DML circuitry 400.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1232, which may be implemented by the machine readable instructions of FIGS. 8-11, may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1212 of FIG. 12. In this example, the processor circuitry 1212 of FIG. 12 is implemented by a microprocessor 1300. For example, the microprocessor 1300 may be a general purpose microprocessor (e.g., general purpose microprocessor circuitry). The microprocessor 1300 executes some or all of the machine readable instructions of the flowchart of FIGS. 8-11 to effectively instantiate the circuitry of FIG. 4A and/or the framework 450 of FIG. 4B as logic circuits to perform the operations corresponding to those machine readable instructions. Ire some such examples, the circuitry of FIG. 4A and/or the structure of the example framework 450 of FIG. 4B is instantiated by the hardware circuits of the microprocessor 1300 in combination with the instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 8-11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may be implemented by at least one of an I2C bus, a SPI bus, a PCI bus, or a PCIe bus

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram of another example implementation of the processor circuitry 1212 of FIG. 12. In this example, the processor circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 8-11 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIGS. 8-11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIGS. 8-11. As such, the FPGA circuitry 1400 may be structured to effectively instantiate some or all of the machine readable instructions of the flowcharts of FIGS. 8-11 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 8-11 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may be implemented by external hardware circuitry. For example, the external hardware 1406 may be implemented by the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations that may correspond to at least some of the machine readable instructions of FIGS. 8-11 and/or other desired operations. The logic gate circuitry 1408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12, many other approaches are contemplated. For example, as mentioned above, modern FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by the flowcharts of FIGS. 8-11 may be executed by one or more of the cores 1302 of FIG. 13, a second portion of the machine readable instructions represented by the flowcharts of FIGS. 8-11 may be executed by the FPGA circuitry 1400 of FIG. 14, and/or a third portion of the machine readable instructions represented by the flowcharts of FIGS. 8-11 may be executed by an ASIC. It should be understood that some or all of the circuitry of FIG. 4A and/or the structure of the example framework 450 of FIG. 4B may, thus, be instantiated at the same or different times. Some or all of the circuitry may be instantiated, for example, in one or more threads executing concurrently and/or in series. Moreover, in some examples, some or all of the circuitry of FIG. 4A and/or the framework 450 of FIG. 4B may be implemented within one or more virtual machines and/or containers executing on the microprocessor.

In some examples, the processor circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

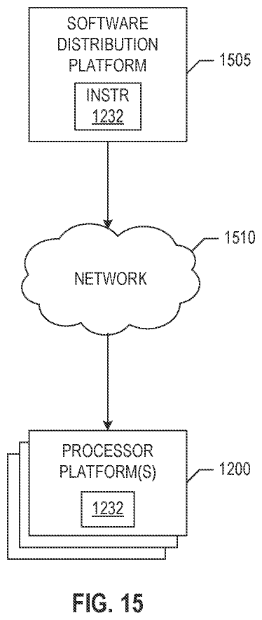

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions of FIGS. 8-11, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions of FIGS. 8-11, may be downloaded to the example processor platform 1200, which is to execute the machine readable instructions 1232 to implement the DML circuitry 400. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices.

From the foregoing, it will be appreciated that example systems, methods, apparatus, and articles of manufacture have been disclosed that improve resource utilization in gradient trees that would otherwise remain idle or dormant until express acknowledgement from a parameter server identifies successful receipt of gradient vectors corresponding to a calculation iteration. While acknowledgement signals from a destination parameter server are important and helpful to verify that a batch of gradient data has not been lost during propagation through the gradient tree structure, examples disclosed herein include middleware header information that is applied to worker node gradient calculations to assist with invocation of reliability protocols that can identify instances where a particular iteration attempt should be repeated (e.g., due to lost vectors during tree propagation). As such, examples disclosed herein override default middleware protocols in aggregation tree structure to permit worker node gradient calculation iterations to occur without first receiving express acknowledgement from the destination parameter server, thereby permitting more efficient resource utilization (e.g., reducing wasted idle time of the worker nodes and/or intermediate INAs). Accordingly, examples disclosed herein improve the operation of a machine by reducing wasted idle time.

Example methods, apparatus, systems, and articles of manufacture to improve distributed machine learning efficiency are disclosed herein. Further examples and combinations thereof include the following:

Example 1 includes an apparatus to accelerate processing iterations, comprising train management circuitry to cause a first vector to be sent from a worker node to an in-network-aggregator (INA) after completion of a first processing iteration requested by a parameter server, and protocol configuration circuitry to prohibit a second processing iteration when an availability status of the INA is false, and permit the second processing iteration when (a) an acknowledgement (ACK) from the INA corresponding to the first vector is received and (b) the availability status of the INA is true.

Example 2 includes the apparatus as defined in example 1, further including resource location circuitry to select the worker node based on a proximity to the INA.

Example 3 includes the apparatus as defined in example 2, wherein the resource location circuitry is to determine the proximity is based on at least one of a physical distance metric or a node hop metric.

Example 4 includes the apparatus as defined in example 1, further including resource determination circuitry to form an aggregation tree between the parameter server, a plurality of worker nodes, and a plurality of INAs.

Example 5 includes the apparatus as defined in example 4, wherein the protocol configuration circuitry is to prevent resource stalling by permitting the second processing iteration before the parameter server receives the first vector.

Example 6 includes the apparatus as defined in example 1, wherein the protocol configuration circuitry is to cause a first model to be sent from the parameter server to the worker node.

Example 7 includes the apparatus as defined in example 6, wherein the protocol configuration circuitry is to cause the worker node to calculate gradient data based on the first model, the worker node to send the gradient data to the INA as the first vector.

Example 8 includes an apparatus to facilitate distributed machine learning, comprising memory, machine readable instructions, and processor circuitry to at least one of instantiate or execute the machine readable instructions to cause a first data packet to be sent from a computing resource to an in-network-aggregator (INA) after completion of a first processing iteration requested by a parameter server, prohibit a second processing iteration when an availability status of the INA is false, and permit the second processing iteration when (a) an acknowledgement (ACK) from the INA corresponding to the first data packet is received and (b) the availability status of the INA is true.

Example 9 includes the apparatus as defined in example 8, wherein the processor circuitry is to select the computing resource based on a proximity to the INA.

Example 10 includes the apparatus as defined in example 9, wherein the proximity is based on at least one of a physical distance metric or a node hop metric.

Example 11 includes the apparatus as defined in example 8, wherein the processor circuitry is to form an aggregation tree between the parameter server, a plurality of computing resources, and a plurality of INAs.

Example 12 includes the apparatus as defined in example 11, wherein the processor circuitry is to prevent resource stalling by permitting the second processing iteration before the parameter server receives the first data packet.

Example 13 includes the apparatus as defined in example 8, wherein the processor circuitry is to cause a first model to be sent from the parameter server to the computing resource.

Example 14 includes the apparatus as defined in example 13, wherein the processor circuitry is to cause the computing resource to calculate gradient data based on the first model, the computing resource to send the gradient data to the INA as the first data packet.

Example 15 includes a non-transitory machine readable storage medium comprising instructions that, when executed, cause processor circuitry to at least complete a first processing iteration requested by an orchestrator computing device, cause a first vector to be sent from a computing resource to an aggregator, prevent a second processing iteration when the aggregator is not available, and permit the second processing iteration to occur when (a) an acknowledgement (ACK) from the aggregator corresponding to the first vector is received and (b) the aggregator is available.

Example 16 includes the machine readable storage medium as defined in example 15, wherein the instructions, when executed, cause the processor circuitry to select the computing resource based on a proximity to the aggregator.

Example 17 includes the machine readable storage medium as defined in example 16, wherein the instructions, when executed, cause the processor circuitry to determine the proximity based on at least one of a physical distance metric or a node hop metric.

Example 18 includes the machine readable storage medium as defined in example 15, wherein the instructions, when executed, cause the processor circuitry to generate an aggregation tree between the orchestrator, a plurality of computing resources, and a plurality of aggregators.

Example 19 includes the machine readable storage medium as defined in example 18, wherein the instructions, when executed, cause the processor circuitry to prevent resource stalling by permitting the second processing iteration before the orchestrator receives the first vector.

Example 20 includes the machine readable storage medium as defined in example 15, wherein the instructions, when executed, cause the processor circuitry to cause a first model to be sent from the orchestrator to the computing resource.

Example 21 includes the machine readable storage medium as defined in example 20, wherein the instructions, when executed, cause the processor circuitry to cause the computing resource to calculate gradient data based on the first model, the computing resource to send the gradient data to the aggregator as the first vector.

Example 22 includes a method to improve distributed machine learning training, comprising sending a first data packet from a computing node to an in-network-aggregator (INA) after completion of a first processing iteration requested by a parameter server, preventing a second processing iteration when an availability status of the INA is false, and permitting the second processing iteration when (a) an acknowledgement (ACK) from the INA corresponding to the first data packet is received and (b) the availability status of the INA is true.

Example 23 includes the method as defined in example 22, further including selecting the computing node based on a proximity to the INA.

Example 24 includes the method as defined in example 23, wherein the proximity is based on at least one of a physical distance metric or a node hop metric.

Example 25 includes the method as defined in example 22, further including generating an aggregation tree between the parameter server, a plurality of computing nodes, and a plurality of INAs.

Example 26 includes the method as defined in example 25, further including preventing resource stalling by permitting the second processing iteration before the parameter server receives the first data packet.

Example 27 includes the method as defined in example 22, further including sending a first model from the parameter server to the computing node.

Example 28 includes the method as defined in example 27, further including causing the computing node to calculate gradient data based on the first model, the computing node to send the gradient data to the INA as the first data packet.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to accelerate processing iterations, comprising:
train management circuitry to cause a first vector to be sent from a worker node to an in-network-aggregator (INA) after completion of a first processing iteration requested by a parameter server; and
protocol configuration circuitry to:
prohibit a second processing iteration when an availability status of the INA is false; and
permit the second processing iteration when (a) an acknowledgement (ACK) from the INA corresponding to the first vector is received and (b) the availability status of the INA is true.

2. The apparatus as defined in claim 1, further including resource location circuitry to select the worker node based on a proximity to the INA.

3. The apparatus as defined in claim 2, wherein the resource location circuitry is to determine the proximity is based on at least one of a physical distance metric or a node hop metric.

4. The apparatus as defined in claim 1, further including resource determination circuitry to form an aggregation tree between the parameter server, a plurality of worker nodes, and a plurality of INAs.

5. The apparatus as defined in claim 4, wherein the protocol configuration circuitry is to prevent resource stalling by permitting the second processing iteration before the parameter server receives the first vector.

6. The apparatus as defined in claim 1, wherein the protocol configuration circuitry is to cause a first model to be sent from the parameter server to the worker node.

7. The apparatus as defined in claim 6, wherein the protocol configuration circuitry is to cause the worker node to calculate gradient data based on the first model, the worker node to send the gradient data to the INA as the first vector.

8. An apparatus to facilitate distributed machine learning, comprising:
memory;
machine readable instructions; and
processor circuitry to at least one of instantiate or execute the machine readable instructions to:
cause a first data packet to be sent from a computing resource to an in-network-aggregator (INA) after completion of a first processing iteration requested by a parameter server;
prohibit a second processing iteration when an availability status of the INA is false; and
permit the second processing iteration when (a) an acknowledgement (ACK) from the INA corresponding to the first data packet is received and (b) the availability status of the INA is true.

9. The apparatus as defined in claim 8, wherein the processor circuitry is to select the computing resource based on a proximity to the INA.

10. The apparatus as defined in claim 9, wherein the proximity is based on at least one of a physical distance metric or a node hop metric.

11. The apparatus as defined in claim 8, wherein the processor circuitry is to form an aggregation tree between the parameter server, a plurality of computing resources, and a plurality of INAs.

12. The apparatus as defined in claim 11, wherein the processor circuitry is to prevent resource stalling by permitting the second processing iteration before the parameter server receives the first data packet.

13. The apparatus as defined in claim 11, wherein the processor circuitry is to prevent INA stalling by permitting the second processing iteration when an indication of INA availability is detected.

14. The apparatus as defined in claim 13, wherein the processor circuitry is to permit the second processing iteration before data corresponding to the first processing iteration has propagated from the computing resource to the parameter server.

15. The apparatus as defined in claim 8, wherein the processor circuitry is to cause a first model to be sent from the parameter server to the computing resource.

16. The apparatus as defined in claim 15, wherein the processor circuitry is to cause the computing resource to calculate gradient data based on the first model, the computing resource to send the gradient data to the INA as the first data packet.

17. A non-transitory machine readable storage medium comprising instructions that, when executed, cause processor circuitry to at least:
complete a first processing iteration requested by an orchestrator computing device;
cause a first vector to be sent from a computing resource to an aggregator;
prevent a second processing iteration when the aggregator is not available; and
permit the second processing iteration to occur when (a) an acknowledgement (ACK) from the aggregator corresponding to the first vector is received and (b) the aggregator is available.

18. The machine readable storage medium as defined in claim 17, wherein the instructions, when executed, cause the processor circuitry to select the computing resource based on a proximity to the aggregator.

19. The machine readable storage medium as defined in claim 18, wherein the instructions, when executed, cause the processor circuitry to determine the proximity based on at least one of a physical distance metric or a node hop metric.

20. The machine readable storage medium as defined in claim 17, wherein the instructions, when executed, cause the processor circuitry to generate an aggregation tree between the orchestrator, a plurality of computing resources, and a plurality of aggregators.

21. The machine readable storage medium as defined in claim 20, wherein the instructions, when executed, cause the processor circuitry to prevent resource stalling by permitting the second processing iteration before the orchestrator receives the first vector.

22. The machine readable storage medium as defined in claim 17, wherein the instructions, when executed, cause the processor circuitry to cause a first model to be sent from the orchestrator to the computing resource.

23. The machine readable storage medium as defined in claim 22, wherein the instructions, when executed, cause the processor circuitry to cause the computing resource to calculate gradient data based on the first model, the computing resource to send the gradient data to the aggregator as the first vector.

24-30. (canceled)
